(19) United States
(12) Patent Application Publication
(10) Pub. No.: US 2006/0224002 A1
(43) Pub. Date: Oct. 5, 2006

(54) CHIRAL DI- AND TRIPHOSPHITES

(75) Inventors: Manfred T. Reetz, Mulheim an der Ruhr (DE); Andreas Meiswinkel, Mulheim an der Ruhr (DE); Gerlinde Mehler, Mulheim an der Ruhr (DE)

Correspondence Address: NORRIS, MCLAUGHLIN & MARCUS, PA, 875 THIRD AVENUE, 18TH FLOOR, NEW YORK, NY, 10022, US

(73) Assignee: STUDIENGESELLSCHAFT KOHLE MBH, Mulheim der Ruhr (DE)

(21) Appl. No.: 11/382,760

(22) Filed: May 11, 2006

(30) Foreign Application Priority Data
Nov. 12, 2003 (DE) 103 52 757.5

(51) Int. Cl. C07F 9/30; C07F 9/80

(52) U.S. Cl. 549/206; 556/20; 549/207

(57) ABSTRACT

The invention claims chiral di- and triphosphites of general formulas (I) or (II), which are bridged by suitable groups. The claimed compounds can be used in asymmetric transition metal catalysis and as chiral transition metal catalysts.

The present invention relates to chiral di- and tri-phosphites with the general formulae I or II which are bridged via suitable groups, to the use of these compounds in asymmetric transition metal catalysis, and to chiral transition metal catalysts.

### STATE OF THE ART

Enantioselective transition metal-catalyzed processes have gained industrial significance in the last 20 years, for example transition metal-catalyzed asymmetric hydrogenation. The ligands required for this purpose are frequently chiral phosphorus ligands (P ligands), for example phosphines, phosphonites, phosphinites, phosphites or phosphoramidites, which are bonded to the transition metals. Typical examples include rhodium, ruthenium or iridium complexes of optically active diphosphines such as BINAP.

The development of chiral ligands entails a costly process consisting of design and trial and error. A complementary search method is so-called combinatorial asymmetric catalysis, in which libraries of modularly constructed chiral ligands or catalysts are prepared and tested, which increases the probability of finding a hit. A disadvantage in all of these systems is the relatively high preparative effort in the preparation of large numbers of ligands, and also the often insufficient enantioselectivity which is observed in the catalysis. It is therefore still an aim of industrial and academic research to prepare novel, inexpensive and particularly high-performance ligands by as simple a route as possible.

While most chiral phosphorus ligands are chelating diphosphorus compounds, especially diphosphines, which bind the particular transition metal as a chelate complex, stabilize it and thus determine the extent of asymmetric induction in the catalysis, it has become known some time ago that certain chiral monophosphonites, monophosphites and monophosphoramidites can likewise be efficient ligands, for example in the rhodium-catalyzed asymmetric hydrogenation of prochiral olefins. Known examples are BINOL-derived representatives, for example ligands A, B and C. Spectroscopic and mechanistic studies indicate that in each case two mono-P ligands are bonded to the metal in the catalysis. The metal-ligand ratio is therefore generally 1:2. Even some chiral monophosphines of the R¹R²R³P type can be good ligands in the transition metal catalysis, although they are generally expensive.

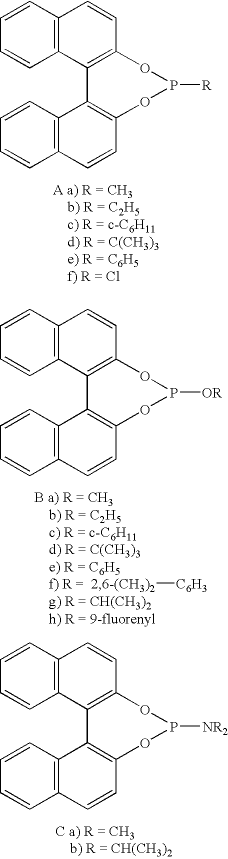

Monophosphorus-containing ligands of the A, B and C type are particularly readily available and can be varied very easily owing to the modular structure. Variation of the R radical in A, B or C allows a multitude of chiral ligands to be constructed, which makes possible ligand optimization in a given transition metal-catalyzed reaction (for example hydrogenation of a prochiral olefin, ketone or imine, or hydroformylation of a prochiral olefin). Unfortunately, limitations of the method exist here too, i.e. many substrates are converted with a moderate or poor enantioselectivity, for example in hydrogenations or hydroformylations. There is therefore still a need for novel, inexpensive and effective chiral ligands for industrial use in transition metal catalysis.

It is accordingly an object of the present invention to make available novel chiral phosphorus ligands which can be prepared easily and, as ligands in transition metal complexes, give rise to catalysts which exhibit a high efficiency in transition metal catalysis, in particular in the hydrogenation, hydroboration and hydrocyanation of olefins, ketones and ketimines.

The present invention accordingly provides chiral compounds with the general formula I or II 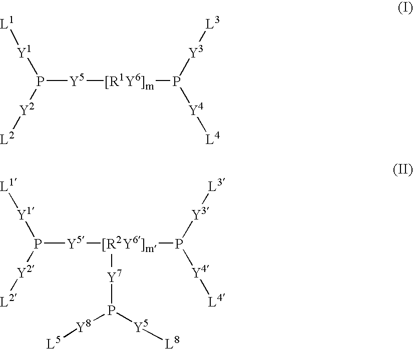
in which
L¹, L², L³, L⁴, L^{1′}, L^{2′}, L^{3′}, L^{4′}, L⁵ and L⁶ may each be the same or different and at least one of L¹, L², L³ and L⁴ in formula I or at least one of L^{1′}, L^{2′}, L^{3′}, L^{4′}, L⁵ and L⁶ in formula II is a chiral radical, where L¹ and L², L³ and L⁴, L^{1′} and L^{2′}, L^{3′} and L^{4′}, and L⁵ and L⁶ may be joined together, Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹ may be the same or different and are each O, S or an NR′ group in which R′ is hydrogen, optionally substituted C₁-C₆-alkyl or optionally substituted aryl, where the substituents may, for example, be selected from F, Cl, Br, I, OH, NO₂, CN, carboxyl, carbonyl, sulfonyl, silyl, CF₃, NR^{a}R^{b} in which R^{a} and R^{b} may be as defined for R¹,
R¹ and R² are each C₂-C₂₂-alkylene, preferably ethylene, n-propylene, isopropylene, n-butylene, isobutylene, sec-butylene, phenylene, diphenylene which may optionally have substituents such as F, Cl, Br, I, OH, NO₂, CN, CF₃, NH₂, sulfonyl, silyl, mono- or di(C₁-C₆) alkylamino, C₁-C₆-alkyl, C₁-C₆-alkoxy, carboxyl or carbonyl, which may optionally in turn have substituents, and
m and m′ are each between 1 and 1000,
with the proviso that, when one of Y⁵ and Y⁶ is O and the other is N(CH₂CH₃) and the L¹Y¹ and L²Y² groups and L³Y³ and L⁴Y⁴ groups in each case together form a binol radical and m is equal to 1, R¹ is not ethylene, and
when Y⁵ and Y⁶ are each O and the L¹Y¹ and L²Y² groups and L³Y³ and L⁴Y⁴ groups in each case together form a binol radical, m is not 4 or 5, and
when the Y⁵—[R¹Y⁶]ₘ moiety in the compound with the formula I is —N(CH₃)—C₂H₄—N(CH₃), —N(CH(CH₃)₂)—C₃H₆—N(CH(CH₃)₂) or —N(CHPhCH₃)—C₃H₆—N(CHPhCH₃), the L¹Y¹ and L²Y² groups and L³Y³ and L⁴Y⁴ groups do not in each case together form a binol radical.

The inventive compounds with the formulae I and II are novel. They can be converted in a simple manner using transition metal salts to the corresponding complexes which in turn exhibit extremely good suitability in transition metal catalysis.

The compounds with the formulae I and II are preferably derivatives of phosphorous acid or of thiophosphorous acid, i.e. Y¹, Y², Y³, Y⁴, Y⁵, Y^{1′}, Y^{2′}, Y^{3′}, Y^{4′}, Y^{5′}, Y⁷, Y⁸, Y⁹ are each oxygen or sulfur. In addition to their good selectivity in the enantioselective transition metal-catalyzed hydrogenation, hydroboration and hydrocyanation, the starting compounds can be prepared in a simple manner or are commercially available inexpensively.

According to the invention, at least one of the L¹, L², L³, L⁴, L^{1′}, L^{2′}, L^{3′}, L^{4′}, L⁵ and L⁶ radicals is chiral, i.e. has one or more optically active elements. Particular preference is given to those ligands which comprise elements with axial chirality.

In a preferred embodiment, the L¹ and L², L³ and L⁴, L^{1′} and L^{2′}, L^{3′} and L^{4′}, and L⁵ and L⁶ radicals are each bridged, particular preference being given to their forming a binol radical. Examples of suitable L¹-Y¹ and L²-Y², L³-Y³, L⁴-Y⁴, L^{1′}-Y^{1′}, L^{2′}-Y^{2′}, L^{3′}-Y^{3′}, L^{4′}-Y^{4′}, L⁵-Y⁵ and L⁶-Y⁶ groups in which these radicals are bridged are:

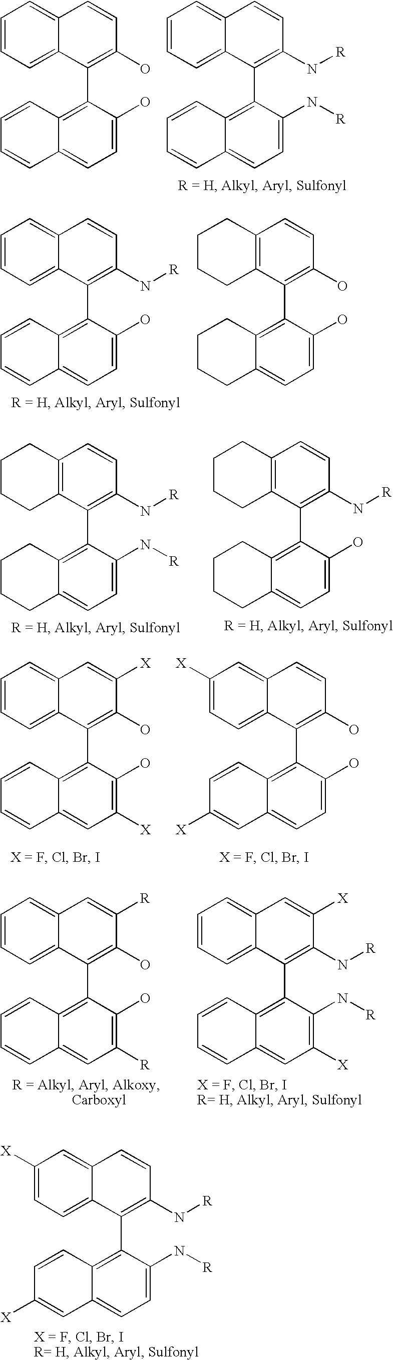

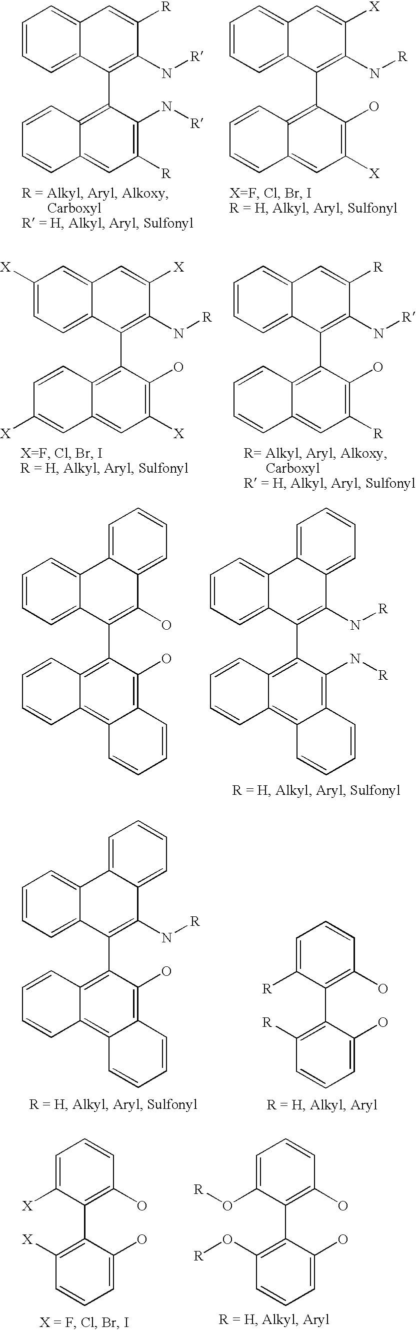

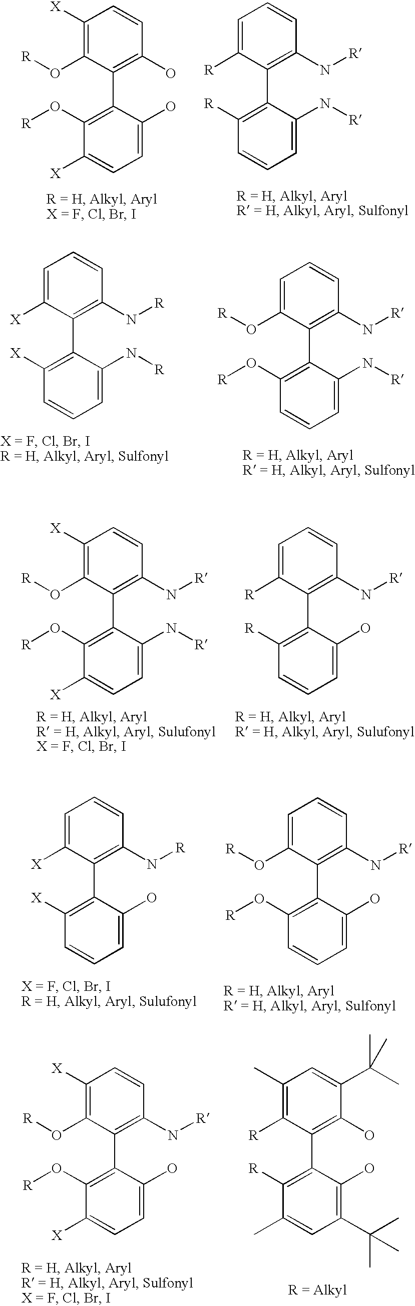

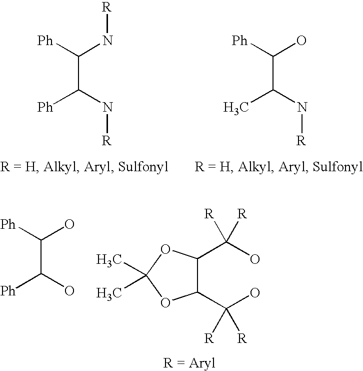

The —Y⁵—[R³Y⁶]ₘ— and —Y^{5′}—[R²Y^{6′}]ₘ— groups join the two chiral phosphorus-containing molecular moieties, and are each alkyleneoxy, thioalkyleneoxy or di- or triamino compounds. Y⁶ and Y^{6′} are preferably each oxygen, so that the groups mentioned are radicals which derive from mono-, di-, oligo- or polyalkylene oxide radicals or polyalkyleneoxy radicals. The R¹Y⁶ and R²Y^{2′} groups derive preferably from ethylene oxide (EO), isopropylene oxide (PO) and glycerol.

In the general formulae I and II, m and m′, in accordance with the invention, are numbers between 1 and 1000, preferably from 1 to 10, in particular from 1 to 6. Especially when the R¹ and R² radicals are each ethylene, n-propylene or isopropylene, m and m′ may each be above 6.

The present invention further provides a process for preparing compounds with the general formula I or II 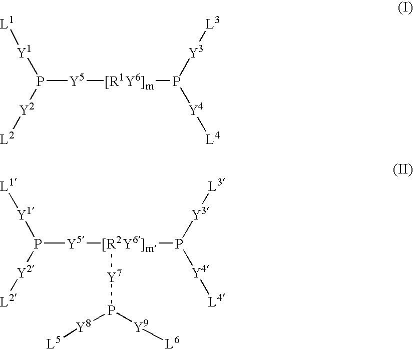
in which
L¹, L², L³, L⁴, L^{1′}, L^{2′}, L^{3′}, L^{4′}, L⁵, L⁶, Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹, R¹, R², m and m′ are each as defined above,
by reacting compounds with the following general formula III 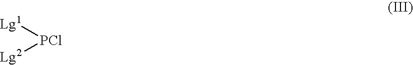
in which
Lg¹ and Lg² may be the same or different and are each a group selected from L¹-Y¹, L²-Y², L³-Y³, L⁴-Y⁴, L^{1′}-Y^{1′}, L^{2′}-Y^{2′}, L^{3′}-Y^{3′}, L^{4′}-Y^{4′}, L⁵-Y⁸ or L⁶-Y⁹,
in the presence of a base of a compound with the general formula IV or V
H—Y⁵—[R¹Y⁶]ₘ—H (IV)
H—Y^{5′}—[R²Y^{6′}]_{m′}—H (V)

In a further possible embodiment for the preparation of the inventive compounds with the formulae I or II, compounds with the general formula VI or VII 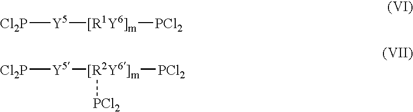
are reacted with ligands of the formula Lg¹ or Lg² to form compounds with the general formulae I or II.

In order to obtain inventive compounds with the formula I or II having at least one chiral center, at least one of the compounds with the formula III to XII has a chiral center or axial chirality. Preference is given to using the pure or enriched enantiomers actually as starting compounds. Enantiomer mixtures of the inventive compounds with the formula I or II can be separated into the pure enantiomers by chemical and physical separation methods in a manner known per se. One example of a physical separation method is chromatography. The separation can be effected by a chemical route by cocrystallization with suitable chiral, enantiomerically enriched assistants, for example chiral enantiomerically pure amines.

When one or more of the L¹ to L⁶ radicals are aryl radicals or bridged aryl radicals, stereoisomers can be separated, for example, by separating the compounds with the formula I or II into the enantiomers by cocrystallization with suitable chiral, enantiomerically enriched assistants, for example chiral enantiomerically pure amines.

The present invention further relates to transition metal catalysts which contain chiral compounds with the general formula I and/or II as ligands.

The present invention further relates to a process for preparing transition metal catalysts containing transition metal complexes of chiral compounds with the general formula I and/or II by reacting transition metal salts in a manner known per se with one or more compounds with the formulae I and/or II.

The catalysts or precatalysts can be prepared by processes well known to those skilled in the art. In these processes, the particular ligands or mixtures of ligands are combined with a suitable transition metal complex. The transition metals which can be used include those of groups IIIb, IVb, Vb, VIIb, VIIb, VIII, Ib and IIb of the periodic table and also lanthanides and actinides. The metals are preferably selected from the transition metals of groups VIII and Ib of the periodic table. In particular, these are transition metal complexes of ruthenium, osmium, cobalt, rhodium, iridium, nickel, palladium, platinum and copper, preferably those of ruthenium, rhodium, iridium, nickel, palladium, platinum and copper.

The transition metal complexes may be common salts such as MXₙ (X=F, Cl, Br, I, BF₄⁻, BAr₄⁻, where Ar is phenyl, benzyl or 3,5-bistrifluoromethylphenyl, SbF₆⁻, PF₆⁻, ClO₄⁻, RCO₂⁽⁻⁾, CF₃SO₃⁽⁻⁾, Acac⁽⁻⁾), for example [Rh(OAc)₂)]₂, Rh(acac)₃, Rh(COD)₂BF₄, Cu(CF₃SO₃)₂, CuBF₄, Ag(CF₃SO₃), Au(CO)Cl, In(CF₃SO₃)₃, Fe(ClO₄)₃, NiCl₂(COD) (COD=1,5-cyclooctadiene), Pd(OAc)₂, [C₃H₅PdCl]₂, PdCl₂(CH₃CN)₂ or La(CF₃SO₃)₃, to name just a few. They may also be metal complexes which bear ligands including olefins, dienes, pyridine, CO or NO (to name just a few). These are displaced fully or partly by the reaction with the P ligands. Cationic metal complexes may likewise be used. The person skilled in the art is familiar with a multitude of possibilities (G. Wilkinson, Comprehensive Coordination Chemistry, Pergamon Press, Oxford (1987); B. Cornils, W. A. Herrmann, Applied Homogeneous Catalysis with Organometallic Compounds, VCH, Weinheim (1996)). Common examples are Rh(COD)₂BF₄, [(cymene)RuCl₂]₂, (pyridine)₂Ir(COD)BF₄, Ni(COD)₂, (TMEDA)Pd(CH₃)₂ (TMEDA=N,N,N′,N′-tetramethylethylenediamine), Pt(COD)₂, PtCl₂(COD) or [RuCl₂(CO)₃]₂, to name just a few.

The metal compound and the ligand, i.e. compounds with the formula I or II, are typically used in such amounts that catalytically active compounds form. Thus, the amount of the metal compound used may, for example, be from 25 to 200 mol % based on the chiral compounds of the general formulae I and/or II used, preferably from 30 to 100 mol %, more preferably from 80 to 100 mol % and even more preferably from 90 to 100 mol %.

The catalysts which contain transition metal complexes generated in situ or isolated transition metal complexes are suitable in particular for use in a process for preparing chiral compounds. The catalysts are preferably used for asymmetric 1,4 additions, asymmetric hydroformylations, asymmetric hydrocyanations, asymmetric hydroborations, asymmetric hydrosilylation, asymmetric hydrovinylation, asymmetric Heck reactions and asymmetric hydrogenations.

Accordingly, the present invention further provides a process for asymmetric transition metal-catalyzed hydrogenation, hydroboration, hydrocyanation, 1,4 addition, hydroformylation, hydrosilylation, hydrovinylation and Heck reaction of prochiral olefins, ketones or ketimines, characterized in that the catalysts have chiral ligands with the above-defined formulae I and/or II.

In a preferred embodiment of the present invention, the transition metal catalysts are used for asymmetric hydrogenation, hydroboration or hydrocyanation of prochiral olefins, ketones or ketimines. End products are obtained in good yield and high purity of the optical isomers.

Preferred asymmetric hydrogenations are, for example, hydrogenations of prochiral C═C bonds, for example prochiral enamines, olefins and enol ethers, C═O bonds, for example prochiral ketones, and C═N bonds, for example prochiral imines. Particularly preferred asymmetric hydrogenations are hydrogenations of prochiral enamines and olefins.

The amount of the metal compound used or of the transition metal complex used may, for example, be from 0.0001 to 5 mol %, based on the substrate used, preferably from 0.0001 to 0.5 mol %, more preferably from 0.0001 to 0.1 mol % and even more preferably from 0.001 to 0.008 mol %.

In a preferred embodiment, asymmetric hydrogenations may, for example, be carried out in such a way that the catalyst is generated in situ from a metal compound and a chiral compound of the general formula I and/or II, optionally in a suitable solvent, the substrate is added and the reaction mixture is placed under hydrogen pressure at reaction temperature.

To perform a hydrogenation, for example, metal compound and ligand are dissolved in degasssed solvent in a baked-out autoclave. The mixture is left to stir for approx. 5 min and then the substrate in degassed solvent is added. After the particular temperature has been established, hydrogenation is effected with elevated H₂ pressure.

Suitable solvents for the asymmetric hydrogenation are, for example, chlorinated alkanes such as methylene chloride, short-chain C₁-C₆ alcohols, for example methanol, isopropanol or ethanol, aromatic hydrocarbons, for example toluene or benzene, ketones, for example acetone, or carboxylic esters, for example ethyl acetate.

The asymmetric hydrogenation is performed, for example, at a temperature of from −20° C. to 200° C., preferably from 0 to 100° C. and more preferably at from 20 to 70° C.

The hydrogen pressure may, for example, be from 0.1 to 200 bar, preferably from 0.5 to 50 bar and more preferably from 0.5 to 5 bar.

The inventive catalysts are suitable in particular in a process for preparing chiral active ingredients of medicaments and agrochemicals, or intermediates of these two classes.

The advantage of the present invention is that it is possible using ligands which are simple to prepare, especially in asymmetric hydrogenations, to achieve good activities with an exceptional selectivity.

### EXAMPLES

### Preparation of Chiral di- and triphosphite Ligands

### Example 1

### Synthesis of bis-O-[(R)-4H-dinaphtho[2,1-d: 1′,2′-f]-[1,3,2]dioxaphosphepin-4,4′-diyl]-1,2-ethanediol (I: L¹Y¹ and L²Y²=L³Y³ and L⁴Y⁴=BINOL; Y⁵=O; R¹Y⁶=(CH₂CH₂O); m=1)

0.93 g (2.65 mmol) of (R)-2,2′-binaphthylphosphorous diester chloride was initially charged at room temperature in 150 ml of abs. diethyl ether. Into this were pipetted 74 μl (0.082 g, 1.32 mmol) of abs. 1,2-ethanediol and 0.41 ml (0.29 g, 2.91 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.71 g (1.03 mmol, 77.9%) of product as colorless powder.

Analysis: ¹H NMR (CD₂Cl₂ 300 MHz) 7.91-7.15 [24H], 3.92 (m) [2H], 3.71 (m) [2H], ¹³C NMR (CD₂Cl₂, 75 MHz) 63.62 (t) J=4.8 Hz; ³¹P NMR (CD₂Cl₂, 121 MHz) 141.53 (s); MS (EI, evaporation temperature 275° C.) m/z=690 (17.29%), 268 (100%), 239 (38.82%) EA P: 8.39% (calc. 8.97%).

### Example 2

### Synthesis of bis-O-[(S)-4H-dinaphtho[2,1-d: 1′,2′-f]-[1,3,2]dioxaphosphepin-4,4′-diyl]-1,3-propanediol (I: L¹Y¹ and L²Y²=L³Y³ and L⁴Y⁴=BINOL; Y⁵=O; Y⁵=O; R¹Y⁶=(CH₂CH₂CH₂O); m=1)

1.97 g (5.62 mmol) of (S)-2,2′-binaphthylphosphorous diester chloride were initially charged at room temperature in 150 ml of abs. diethyl ether. Into this were pipetted 200 μl (0.21 g, 2.81 mmol) of abs. 1,3-propanediol and 0.86 ml (0.62 g, 6.18 mmol) of abs. triethylamine. After stirring overnight, the precipitated colorless solid was filtered off through a D4 frit and washed with 5 ml of abs. diethyl ether. The filtrate was subsequently freed completely of solvent. This afforded 1.6 g (2.27 mmol, 81.1%) of product as colorless powder.

Analysis: ¹H NMR (CD₂Cl₂ 300 MHz) 7.90-7.12 [24H], 3.84 (m) [4H], 1.69 (m) [2H], ¹³C NMR (CD₂Cl₂, 75 MHz) 60.43 (d) J=6.8 Hz; 31.38; ³¹P NMR (CD₂Cl₂, 121 MHz) 141.92 (s); MS (EI, evaporation temperature 280° C.) m/z=704 (22.11%), 373 (100%), 268 (91.9%) EA P: 7.99% (calc. 8.79%).

### Example 3

### Synthesis of (S,S)bis-O-[(S)-4H-dinaphtho[2,1-d: 1′,2′-f]-[1,3,2]dioxaphosphepin-4,4′-diyl]-1,4-butanediol (I: L¹Y¹ and L²Y²=L³Y³ and L⁴Y⁴=BINOL; Y⁵=O; R¹Y⁶=(CH₂CH₂CH₂CH₂O); m=1)

1.10 g (3.13 mmol) of (S)-2,2′-binaphthylphosphorous diester chloride were initially charged at room temperature in 150 ml of abs. diethyl ether. Into this were pipetted 140 μl (0.14 g, 1.56 mmol) of abs. 1,4-butanediol and 0.48 ml (0.35 g, 3.44 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.86 g (1.19 mmol, 76.7%) of product as colorless powder.

Analysis: ¹H NMR (CD₂Cl₂ 300 MHz) 7.90-7.18 [24H], 3.85 (m) [2H], 3.68 (m) [2H], 1.43 (m) [4H]; ¹³C NMR (CD₂Cl₂, 75 MHz) 63.87 (d) J=6.9 Hz; 26.50 (d) J=4.1 Hz; ³¹P NMR (CD₂Cl₂, 121 MHz) 142.72 (s); MS (EI, evaporation temperature 285° C.) m/z=718 (15.05%), 268 (100%), 239 (50.5%) EA P: 8.06% (calc. 8.62%).

### Example 4

### Synthesis of 1,7-bis-O-[(S)-4H-dinaphtho[2,1-d: 1′,2′-f]-[1,3,2]dioxaphosphepin-4,4′-diyl]-1,4,7-trioxaheptane (I: L¹Y¹ and L²Y²=L³Y³ and L⁴Y⁴=BINOL; Y⁵=O; R¹Y⁶=(CH₂CH₂O); m=2)

0.86 g (2.45 mmol) of (S)-2,2′-binaphthylphosphorous ester chloride was initially charged at room temperature in 150 ml of abs. diethyl ether. Into this were pipetted 120 μl (0.13 g, 1.23 mmol) of abs. diethylene glycol and 0.37 ml (0.27 g, 2.69 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.50 g (0.68 mmol, 55.3%) of product as colorless powder.

Analysis: ¹H NMR (CD₂Cl₂ 300 MHz) 7.89-7.14 [24H], 4.01 (m) [2H], 3.87 (m) [2H], 3.52 (m) [4H], ¹³C NMR (CD₂Cl₂, 75 MHz) 69.89 (d) J=5.0 Hz; 63.58 (d) J=5.7 Hz; ³¹P NMR (CD₂Cl₂, 121 MHz) 143.59(s); MS (EI, evaporation temperature 285° C.) m/z=734 (9.05%), 268 (100%), 239 (43.46%) EA C, 69.64% (calc. 71.93%), H, 5.15% (calc. 4.39%), P: 7.84% (calc. 8.43%).

### Example 5

### Synthesis of 1,10-bis-O-[(S)-4H-dinaphtho[2,1-d: 1′,2′-f]-[1,3,2]dioxaphosphepin-4,4′-diyl]-1,4,7,10-tetraoxadecane (I: L¹Y¹ and L²Y²=L³Y³ and L⁴Y⁴=BINOL; Y⁵=O; R¹Y⁶=(CH₂CH₂O); m=3)

0.88 g (2.50 mmol) of (S)-2,2′-binaphthylphosphorous diester chloride was initially charged at room temperature in 150 ml of abs. diethyl ether. Into this were pipetted 170 μl (0.188 g, 1.25 mmol) of abs. triethylene glycol and 0.38 ml (0.28 g, 2.76 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.63 g (0.81 mmol, 64.7%) of product as colorless powder.

Analysis: ¹H NMR (CD₂Cl₂ 300 MHz) 7.86-7.12 [24H], 3.95 (m) [2H], 3.79 (m) [2H], 3.50 (s) [4H], 3.46 (m) [4H]; ¹³C NMR (CD₂Cl₂, 75 MHz) 69.90 (d) J=3.9 Hz; 69.81 (s), 63.61 (d) J=7.2 Hz; ³¹P NMR (CD₂Cl₂, 121 MHz) 143.84 (s); MS (EI, evaporation temperature 275° C.) m/z=778 (8.66%), 376 (34.39%), 268 (100%), 239 (23.95%) EA P: 7.96% (calc. 7.19%).

### Example 6

### Synthesis of 1,13-bis-O-[(S)-4H-dinaphtho[2,1-d:1′,2′-f]-[1,3,2]dioxaphosphepin-4,4′-diyl]-1,4,7,10,13-pentaoxatridecane (I: L¹Y¹ and L²Y²=L³Y³ and L⁴Y⁴=BINOL; Y⁵=O; R¹Y⁶=(CH₂CH₂O); m=4)

1.20 g (3.40 mmol) of (S)-2,2′-binaphthylphosphorous ester chloride were initially charged at room temperature in 150 ml of abs. diethyl ether. Into this were pipetted 290 μl (0.33 g, 1.70 mmol) of abs. tetraethylene glycol and 0.52 ml (0.38 g, 3.74 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.95 g (1.15 mmol, 67.9%) of product as colorless powder.

Analysis: ¹H NMR (CD₂Cl₂ 300 MHz) 7.87-7.16 [24H], 3.95 (m) [2H], 3.82 (m) [2H], 3.51 (s) [8H], 3.41 (m) [4H]; ¹³C NMR (CD₂Cl₂, 75 MHz) 70.27 (s) 69.78 (s), 69.57 (s) 63.67 (d) T=7.1 Hz; ³¹P NMR (CD₂Cl₂, 121 MHz) 143.76 (s); MS (EI, evaporation temperature 300° C.) m/z=376 (29.67%), 268 (100%), 239 (31.44%) EA P: 6.45% (calc. 7.52%).

### Example 7

### Synthesis of 1,16-bis-O-[(S)-4H-dinaphtho[2,1-d:1′,2′-f]-[1,3,2]dioxaphosphepin-4,4′-diyl]-1,4,7,10,13,16-hexaoxahexadecane (I: L¹Y¹ and L²Y²=L³Y³ and L⁴Y⁴=BINOL; Y⁵=O; R¹Y⁶=(CH₂CH₂O); m=5)

0.86 g (2.44 mmol) of (S)-2,2′-binaphthylphosphorous ester chloride was initially charged at room temperature in 150 ml of abs. diethyl ether. Into this were pipetted 260 μl (0.29 g, 1.22 mmol) of abs. pentaethylene glycol and 0.38 ml (0.27 g, 2.70 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.75 g (0.86 mmol, 70.9%) of product as colorless powder.

Analysis: ¹H NMR (CD₂Cl₂ 300 MHz) 7.89-7.13 [24H], 3.95 (m) [2H], 3.80 (m) [2H], 3.46 (s) [12H], 3.45 (m) [4H]; ¹³C NMR (CD₂Cl₂, 75 MHz) 71.70 (s) 69.81 (s), 69.69 (s) 69.51 (s), 63.65 (d); T=7.2 Hz; ³¹P NMR (CD₂Cl₂, 121 MHz) 143.70 (s); MS (EI, evaporation temperature 315° C.) m/z=376 (28.61%), 268 (100%), 239 (42.62%) EA P: 6.60% (calc. 7.14%).

### Example 8

### Synthesis of bis-O-[(S)-4H-dinaphtho[2,1-d:1′,2′-f]-[1,3,2]dioxaphosphepin-4,4′-diyl]-1,2-dihydroxybenzene (I: L¹Y¹ and L²Y²=L³Y³ and L⁴Y⁴=BINOL; Y⁵=O; R¹Y⁶=(C₆H₅O); m=1)

0.73 g (2.07 mmol) of (S)-2,2′-binaphthylphosphorous ester chloride was initially charged in 150 ml of abs. diethyl ether at room temperature and 0.32 ml (0.23 g, 2.28 mmol) of abs. triethylamine was pipetted in. The solution was cooled to −80° C. To this was added dropwise 0.114 g (1.035 mmol) of 1,2-dihydroxybenzene in 20 ml of diethyl ether within 1 h and the suspension was warmed to room temperature. After stirring overnight, the precipitated colorless solid was filtered through a D4 frit and washed with 5 ml of abs. diethyl ether. The filtrate was subsequently freed completely of solvent. 0.54 g (0.73 mmol, 70.6%) of product was obtained as colorless powder. Analysis: ¹H NMR (CD₂Cl₂, 300 MHz) 7.96-6.38 [28H]; ³¹P NMR (CD₂Cl₂, 121 MHz) 145.65 (s); EA P: 7.71% (calc. 8.38%).

### Example 9

### Synthesis of bis-O-[(S)-4H-dinaphtho[2,1-d:1′,2′-f]-[1,3,2]dioxaphosphepin-4,4′-diyl]-1,3-dihydroxybenzene (I: L¹Y¹ and L²Y²=L³Y³ and L⁴Y⁴=BINOL; Y⁵=O; R¹Y⁶=C₆H₅O; m=1)

0.44 g (1.26 mmol) of (S)-2,2′-binaphthylphosphorous ester chloride was initially charged at room temperature in 150 ml of abs. diethyl ether. Into this were pipetted 0.07 g (0.63 mmol) of 1,3-dihydroxybenzene and 0.19 ml (0.14 g, 1.38 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.29 g (0.39 mmol, 62.3%) of product as colorless powder.

Analysis: ¹H NMR (CD₂Cl₂ 300 MHz) 7.95-6.94 [28H]; ³¹P NMR (CD₂Cl₂, 121 MHz) 144.81; MS (EI, evaporation temperature 285° C.) m/z=738 (63.22%), 315 (88.94%), 268 (100%), 239 (20.42%); EA P: 7.32% (calc. 8.38%).

### Example 10

### Synthesis of bis-O-[(S)-4H-dinaphtho[2,1-d:1′,2′-f]-[1,3,2]dioxaphosphepin-4,4′-diyl]-1,4-dihydroxybenzene (I: L¹Y¹ and L²Y²=L³Y³ and L⁴Y⁴=BINOL; Y⁵=O; R¹Y⁶=(C₆H₅O); m=1)

0.56 g (1.60 mmol) of (S)-2,2′-binaphthylphosphorous ester chloride was initially charged at room temperature in 150 ml of abs. diethyl ether. Into this were pipetted 0.088 g (0.80 mmol) of 1,4-dihydroxybenzene and 0.24 ml (0.18 g, 1.76 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.26 g (0.35 mmol, 44.0%) of product as colorless powder.

Analysis: ¹H NMR (CD₂Cl₂ 300 MHz) 8.13-7.29 [28H]; ³¹P NMR (CD₂Cl₂, 121 MHz) 145.44; MS (EI, evaporation temperature 200° C.) m/z=738 (42.75%), 315 (100%), 268 (69.45%), 239 (15.08%); EA P: 7.67% (calc. 8.38%).

### Example 11

### Synthesis of bis-O-[(S)-4H-dinaphtho[2,1-d:1′,2′-f]-[1,3,2]dioxaphosphepin-4,4′-diyl]-1,2-bis(hydroxymethyl)benzene (I: L¹Y¹ and L²Y²=L³Y³ and L⁴Y⁴=BINOL; Y⁵=O; R¹Y⁶=CH₂C₆H₅CH₂O, m=1)

1.0 g (2.85 mmol) of (S)-2,2′-binaphthylphosphorous ester chloride was initially charged at room temperature in 150 ml of abs. diethyl ether. Into this were pipetted 0.20 g (1.42 mmol) of 1,2-bis(hydroxymethyl)benzene and 0.44 ml (0.32 g, 3.13 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.62 g (0.81 mmol, 57.0%) of product as colorless powder.

Analysis: ¹H NMR (CD₂Cl₂ 300 MHz) 7.87-7.09 [28H], 5.14 (m) [2H], 4.75 (m) [2H]; ¹³C NMR (CD₂Cl₂, 75 MHz) 63.37 (d) J=6.4 Hz; ³¹P NMR (CD₂Cl₂, 121 MHz) 140.97 (s); EA P: 7.43% (calc. 8.08%).

### Example 12

### Synthesis of bis-O-[(S)-4H-dinaphtho[2,1-d:1′,2′-f]-[1,3,2]dioxaphosphepin-4,4′-diyl]-1,1′-biphenol (I L¹Y¹ and L²Y²=L³Y³ and L⁴Y⁴=BINOL; Y⁵=O; R¹Y⁶=C₆H₅C₆H₅O)

1.1 g (3.10 mmol) of (S)-2,2′-binaphthylphosphorous ester chloride were initially charged at room temperature in 150 ml of abs. diethyl ether. Into this were pipetted 0.29 g (1.55 mmol) of 1,1′-biphenol and 0.48 ml (0.34 g, 3.40 mmol) of abs. triethylamine. After stirring overnight, the precipitated colorless solid was filtered off through a D4 frit and washed with 5 ml of abs. diethyl ether. The filtrate was subsequently freed completely of solvent. This afforded 1.03 g (1.26 mmol, 81.6%) of product as colorless powder.

Analysis: ¹H NMR (CD₂Cl₂ 300 MHz) 7.87-7.09 [32H]; ³¹P NMR (CD₂Cl₂, 121 MHz) 145.23 (s); MS (EI, evaporation temperature 250° C.) m/z=814 (0.28%), 483 (100%), 268 (10.14%), 168 (18.62%); EA P: 7.15% (calc. 7.60%).

### Example 13

### Synthesis of 4,4′-bis-O-[(S)-4H-dinaphtho[2,1-d:1′,2′-f]-[1,3,2]dioxaphosphepin-4,4′-diyl]isopropylidenediphenol (I: L¹Y¹ and L²Y²=L³Y³ and L⁴Y⁴=BINOL; Y⁵=O; R¹Y⁶=C₆H₅C(CH₃)₂C₆H₅O)

0.68 g (1.94 mmol) of (S)-2,2′-binaphthylphosphorous ester chloride was initially charged at room temperature in 150 ml of abs. diethyl ether. Into this were pipetted 0.22 g (0.97 mmol) of 4,4′-isopropylidenediphenol and 0.30 ml (0.21 g, 2.13 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.63 g (0.73 mmol, 75.2%) of product as colorless powder.

Analysis: ¹H NMR (CD₂Cl₂ 300 MHz) 7.90-6.98 [32H], 1.55 (s) [6H]; ³¹P NMR (CD₂Cl₂, 121 MHz) 145.21 (s); MS (EI, evaporation temperature 325° C.) m/z=856 (41.56%), 841 (24.68%), 315 (100%), 268 (73.43%) EA P: 6.58% (calc. 7.23%).

### Example 14

### Synthesis of 1,3,5-tris-O-[(S)-4H-dinaphtho[2,1-d:1′,2′-f]-[1,3,2]dioxaphosphepin-4,4′-diyl]benzene (II: L^{1′}Y^{1′} and L^{2′}Y^{2′}=L^{3′}Y^{3′} and L^{4′}Y^{4′}=L⁵Y⁸ and L⁶Y⁹=BINOL; Y⁵=O; R^{2′}Y^{6′}=C₆H₃O; m=1)

1.15 g (3.28 mmol) of (S)-2,2′-binaphthylphosphorous ester chloride were initially charged at room temperature in 150 ml of abs. diethyl ether. Into this were pipetted 0.137 g (1.09 mmol) of 1,3,5-trihydroxybenzene and 0.30 ml (0.36 g, 3.61 mmol) of abs. triethylamine. After stirring overnight, the precipitated colorless solid was filtered off through a D4 frit and washed with 5 ml of abs. diethyl ether. The filtrate was subsequently freed completely of solvent. This afforded 0.92 g (0.86 mmol, 79.0%) of product as colorless powder.

Analysis: ¹H NMR (CD₂Cl₂ 300 MHz) 7.95-7.13 [36H], 6.77 (s) [3H]; ³¹P NMR (CD₂Cl₂, 121 MHz) 144.06 (s); EA P: 8.29% (calc. 8.69%).

### Example 15

### Synthesis of tris-O-[(S)-4H-dinaphtho[2,1-d:1′,2′-f]-[1,3,2]dioxaphosphepin-4,4′-diyl]-2,2′,2″-nitrilotriethanol (II: L^{1′}Y^{1′} and L^{2′}Y^{2′}=L^{3′}Y^{3′} and L^{4′}Y^{4′}=L⁵Y⁸ and L⁶Y⁹=BINOL; Y^{5′}=Y^{6′}-Y⁷ O; R²=N(C₂H₄)₃; m

1.26 g (3.60 mmol) of (S)-2,2′-binaphthylphosphorous ester chloride was initially charged at room temperature in 150 ml of abs. diethyl ether. Into this were pipetted 160 μl (0.18 g, 1.2 mmol) of triethanolamine and 0.55 ml (0.40 g, 3.95 mmol) of abs. triethylamine. After stirring overnight, the precipitated colorless solid was filtered off through a D4 frit and washed with 5 ml of abs. diethyl ether. The filtrate was subsequently freed completely of solvent. This afforded 1.02 g (0.93 mmol, 77.8%) of product as colorless powder.

Analysis: ¹H NMR (CD₂Cl₂ 300 MHz) 7.98-7.07 [36H], 3.71 (m) [6H], 2.59 (t) [6H] J=5.7 Hz; ³¹P NMR (CD₂Cl₂, 121 MHz) 143.08 (s); EA P: 7.92% (calc. 8.51%).

### Examples 16-18

### General Method for the Synthesis of Ligands which Derive from Amino Alcohols

600 mg (1.71 mmol) of (S)-2,2′-binaphthylphosphorous ester chloride and 0.3 ml (2.16 mmol) of triethylamine were initially charged in 100 ml of toluene at −78° C. and admixed in each case with 0.5 equivalent (0.86 mmol) of the appropriate amino alcohol. After stirring for 16 h and warming to room temperature, the precipitate formed was filtered off and the filtrate was freed completely of solvent. After drying under high vacuum, the ligands were isolated as white solids in yields between 42% and 99%.

### Example 16

### bis-O-[(S)-4H-Dinaphtho[2,1-d:1′,2′-f]-[1,3,2]dioxaphosphepin-4,4′-diyl]-N-methyl-2-aminoethanol (I: L¹Y¹ and L²Y²=L³Y³ and L⁴Y⁴=BINOL; Y⁵=NCH₃; R¹Y⁶=(CH₂CH₂O); m=1)

Analysis: ¹H NMR (C₆D₆, 300.1 MHz) δ=7.70-6.90 (m) [24H], 3.75 (m, 1H), 3.48 (m) [1H], 3.11 (m) [1H], 2.67 (m) [1H], 2.15 (d, J_{PH}=5.3 Hz) [3H]; ³¹P NMR (C₆D₆, 121.5 MHz) 149.8 (s) 139.0 (s); MS (EI, pos. ions): m/z=703 [M]⁺.

### Example 17

### bis-N,O-[(S)-4H-Dinaphtho[2,1-d:1′,2′-f]-[1,3,2]dioxaphosphepin-4,4′-diyl]-3-aminopropanol (I: L¹Y¹ and L²Y²=L³Y³ and L⁴Y⁴=BINOL; Y⁵=NH; R¹Y⁶=(CH₂CH₂CH₂O); m=1)

Analysis: ¹H NMR (C₆D₆, 400.1 MHz) 7.71-6.86 (m) [24H], 3.71 (m) [1H], 3.52 (m) [1H], 2.79-2.66 (m) [2H], 2.60 (m) [1H], 1.16 (m) [2H]; ³¹P NMR (C₆D₆, 162.0 MHz) 153.9 (s) 139.4 (s); MS (EI, pos. ions): m/z=703 [M]⁺; EA C, 72.68% (calc. 73.40%), H, 4.80% (calc. 4.44%), N 1.67% (calc. 1.99%), P: 8.44% (calc. 8.80%).

### Example 18

### bis-N,O-[(S)-4H-Dinaphtho[2,1-d:1′,2′-f]-[1,3,2]dioxaphosphepin-4,4′-diyl]-4-aminobutanol (I: L¹Y¹ and L²Y²=L³Y³ and L⁴Y⁴=BINOL; Y⁵=NH; R¹Y⁶=(CH₂CH₂CH₂CH₂O); m=1)

Analysis: ¹H NMR (C₆D₆, 400.1 MHz) 7.69-6.88 (m) [24H], 3.70 (m) [1H], 3.50 (m) [1H], 2.63 (m) [1H], 2.55-2.41 (m) [2H], 1.12 (m) [2H]; 1.04 (m) [2H]; ³¹P NMR (C₆D₆, 162.0 MHz) 153.8 (s), 140.0 (s); MS (EI, pos. ions): m/z=717 [M]⁺; EA C, 73.58% (calc. 73.64%), H: 4.70% (calc. 4.63%), N, 2.06% (calc. 1.95%), P: 8.52% (calc. 8.63%).

### Hydrogenations

General Method for Hydrogenation with Catalyst Prepared In Situ

0.5 ml of a 2 mM solution of [Rh(cod)₂] BF₄ in dichloromethane was initially charged in a round-bottom flask with side tap. To this were added 0.5 ml of a 2 mM solution of the ligands specified and then 9.0 ml of a 0.11M substrate solution in dichloromethane. The solution was then saturated with hydrogen and stirred at room temperature for 20 h under 1.3 bar of hydrogen pressure. 2 ml of the solution thus obtained were filtered through silica (70-230 mesh, activity level I) and analyzed by gas chromatography.

### Examples 19-36

### Enantioselective Hydrogenation of Dimethyl Itaconate

Examples 19-36 describe the hydrogenation of the dimethyl itaconate substrate to dimethyl 2-methylsuccinate by the “general method for hydrogenation with catalyst prepared in situ”. The precise reaction conditions and the conversions and enantioselectivities achieved are reported in Table 1.

TABLE 1

| | Ligand L | Conversion | ee | |
|---|---|---|---|---|
| Ex. | from Example | in %^{[a]} | in % | Config. |
| 19 | 1 | 83.0 | 48.4 | (R) |
| 20 | 2 | 43.7 | 37.6 | (S) |
| 21 | 3 | 95.6 | 93.4 | (S) |
| 22 | 4 | 96.8 | 96.8 | (S) |
| 23 | 5 | 37.9 | 56.4 | (S) |
| 24 | 6 | 97.4 | 95.8 | (S) |
| 25 | 7 | 23.1 | 6.4 | (S) |
| 26 | 8 | 7.0 | 5.4 | (S) |
| 27 | 9 | 95.5 | 84.6 | (S) |
| 28 | 10 | 99.1 | 91.0 | (S) |
| 29 | 11 | 88.6 | 49.6 | (S) |
| 30 | 12 | 8.2 | 10.6 | (S) |
| 31 | 13 | 88.6 | 49.6 | (S) |
| 32 | 14 | 5.1 | 30.8 | (S) |
| 33 | 15 | 1.8 | 43.0 | (S) |
| 34 | 16 | 83.0 | 34.6 | (S) |
| 35 | 17 | 100 | 82.4 | (S) |
| 36 | 18 | 100 | 86.6 | (S) |

^{[a]}If no reactant was detectable any longer by gas chromatography, 100% conversion is reported.

### Examples 37-41

### Enantioselective Hydrogenation of methyl 2-acetamidoacrylate

Examples 37-41 describe the hydrogenation of the methyl 2-acetamidoacrylate substrate to methyl N-acetylalaninate by the “general method for hydrogenation with catalyst prepared in situ”. The precise reaction conditions and the conversions and enantioselectivities achieved are reported in Table 2.

TABLE 2

| | Ligand L | Conversion | ee | |
|---|---|---|---|---|
| Ex. | from Example | in %^{[a]} | in % | Config. |
| 37 | 3 | 100 | 69.6 | (R) |
| 38 | 4 | 100 | 78.8 | (R) |
| 39 | 16 | 98.0 | rac. | — |
| 40 | 17 | 100 | 36.0 | (R) |
| 41 | 18 | 100 | 88.8 | (R) |

^{[a]}If no reactant was detectable any longer by gas chromatography, 100% conversion is reported.

### Examples 42-43

### Enantioselective Hydrogenation of methyl α-acetamidocinnamate

Examples 42-43 describe the hydrogenation of the methyl α-acetamidocinnamate substrate to methyl N-acetylphenylalaninate by the “general method for hydrogenation with catalyst prepared in situ”. The precise reaction conditions and the conversions and the enantioselectivities achieved are reported in Table 3.

TABLE 3

| | Ligand L | Conversion | ee | |
|---|---|---|---|---|
| Ex. | from Example | in %^{[a]} | in % | Config. |
| 42 | 3 | 89.2 | 58.8 | (R) |
| 43 | 4 | 81.5 | 63.6 | (R) |

### Examples 44-48

### Enantioselective Hydrogenation of α-acetamidostyrene

Examples 44-48 describe the hydrogenation of the α-acetamidostyrene substrate to N-acetyl-1-phenylethylamine. 0.5 ml of a 2 mM ligand solution was admixed with 0.5 ml of a 2 mM solution of [Rh(cod)₂]BF₄. After adding 2.0 ml of a 0.25 M substrate solution, the mixture was stirred at 60 bar of hydrogen pressure for 20 h. 2 ml of the solution thus obtained were filtered through silica (70-230 mesh), activity level I) and analyzed by gas chromatography. The precise reaction conditions and the conversions and enantioselectivities achieved are reported in Table 4.

TABLE 4

| | Ligand L | Conversion | ee | |
|---|---|---|---|---|
| Ex. | from Example | in %^{[a]} | in % | Config. |
| 44 | 3 | 72.1 | 78.4 | (R) |
| 45 | 4 | 67.7 | 76.4 | (R) |
| 46 | 16 | 100 | 19.2 | (S) |
| 47 | 17 | 100 | 56.0 | (R) |
| 48 | 18 | 100 | 62.6 | (R) |

^{[a]}If no reactant was detectable any longer by gas chromatography, 100% conversion is reported.

### Examples 49-51

### Enantioselective Hydrogenation of 1-phenylvinyl Acetate

Examples 49-51 describe the hydrogenation of the 1-phenylvinyl acetate substrate to 1-phenylethanol acetate. 0.25 ml of a 2 mM ligand solution was admixed with 0.25 ml of a 2 mM solution of [Rh(cod)₂]BF₄. After adding 1.0 ml of a 0.1 M substrate solution and 2.0 ml of dichloromethane, the mixture was stirred at 60 bar of hydrogen pressure for 20 h. 2 ml of the solution thus obtained were filtered through silica (70-230 mesh, activity level I) and analyzed by gas chromatography. The precise reaction conditions and the conversions and enantioselectivities achieved are reported in Table 5.

TABLE 5

| | Ligand L | Conversion | ee | |
|---|---|---|---|---|
| Ex. | from Example | in %^{[a]} | in % | Config. |
| 49 | 16 | 100 | 76.6 | (S) |
| 50 | 17 | 100 | 59.8 | (S) |
| 51 | 18 | 100 | 31.4 | (S) |

^{[a]}If no reactant was detectable any longer by gas chromatography, 100% conversion is reported.

1. A chiral compound with the formula I or II 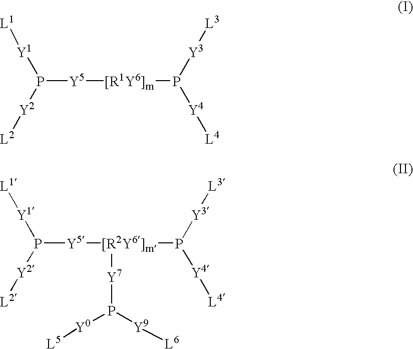
in which
L¹, L², L³, L⁴, L^{1′}, L^{2′}, L^{3′}, L^{4′}, L⁵ and L⁶ may each be the same or different and at least one of L¹, L², L³ and L⁴ in formula I or at least one of L^{1′}, L^{2′}, L^{3′}, L^{4′}, L⁵ and L⁶ in formula II is a chiral radical, where L¹ and L², L³ and L⁴, L^{1′} and L^{2′}, L^{3′} and L^{4′}, and L⁵ and L⁶ may be joined together,
Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹ may be the same or different and are each O, S or an NR′ group in which R′ is hydrogen, optionally substituted C₁-C₆-alkyl or optionally substituted aryl, R¹ and R² are each optionally substituted C₂-C₂₂-alkylene, and
m and m′ are each between 1 and 1000,
with the proviso that, when one of Y⁵ and Y⁶ is O and the other is N(CH₂CH₃) and the L¹Y¹ and L²Y² groups and L³Y³ and L⁴Y⁴ groups in each case together form a binol radical and m is equal to 1, R¹ is not ethylene, and
when Y⁵ and Y⁶ are each O and the L¹Y¹ and L²Y² groups and L³Y³ and L⁴Y⁴ groups in each case together form a binol radical, m is not 4 or 5, and
when the Y⁵—[R¹Y⁶]ₘ moiety in the compound with the formula I is —N(CH₃)—C₂H₄—N(CH₃), —N(CH(CH₃)₂)—C₃H₆—N(CH(CH₃)₂) or —N(CHPhCH₃)—C₃H₆—N(CHPhCH₃), the L¹Y¹ and L²Y² groups and L³Y³ and L⁴Y⁴ groups do not in each case together form a binol radical.

2. A compound as claimed in claim 1, wherein the R¹Y⁶ and R²Y^{6′} groups are derived from ethylene oxide or propylene oxide.

3. A compound as claimed in claim 1, wherein L¹ and L², L³ and L⁴, L^{1′} and L^{2′}, L^{3′} and L^{4′}, and L⁵ and L⁶ are each bridged.

4. A compound as claimed in claim 1, Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹ are each oxygen or sulfur.

5. A compound as claimed in claim 4, wherein the bridged ligands are selected from

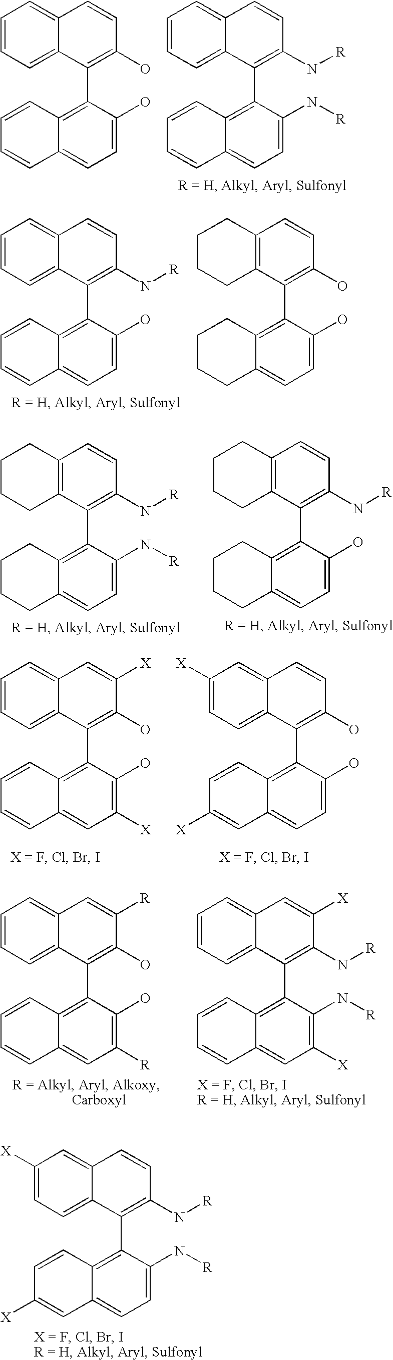

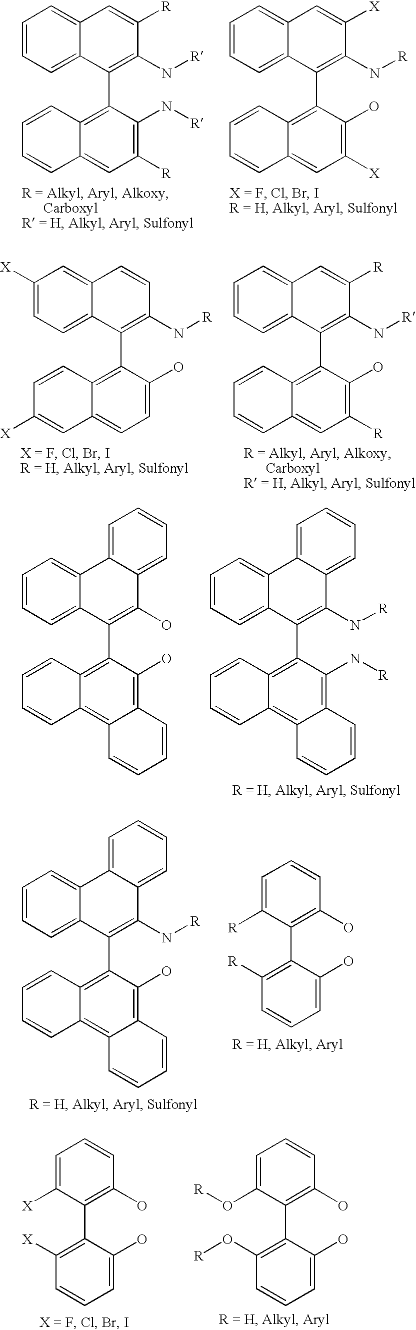

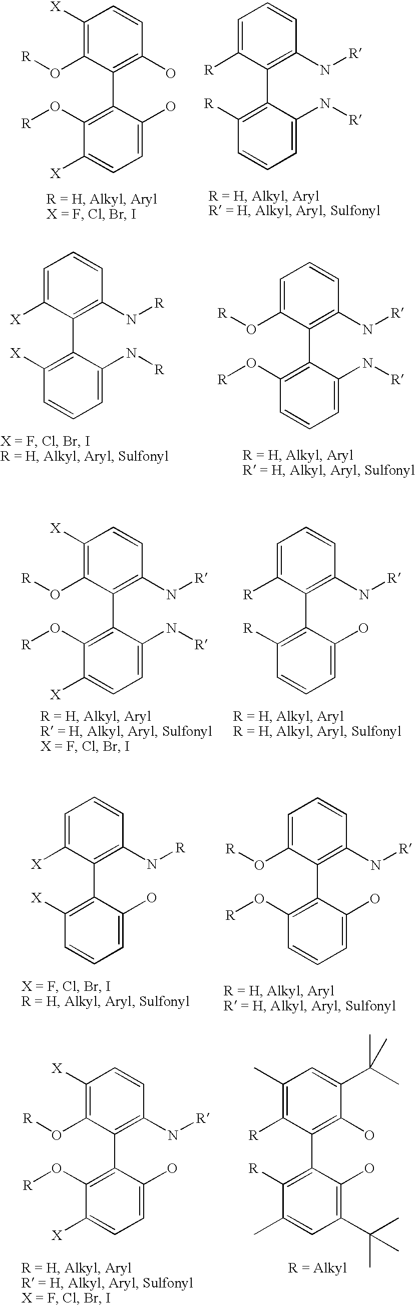

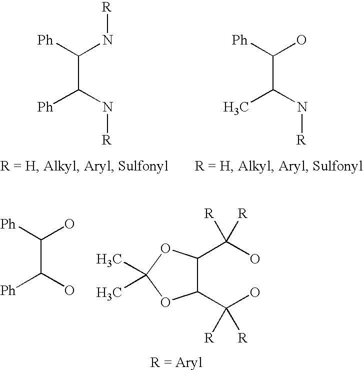

6. A process for preparing compounds with the formula I or II 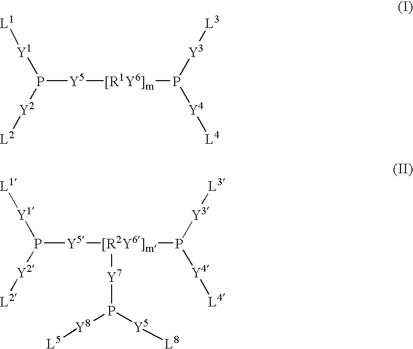
in which L¹, L², L³, L⁴, L^{1′}, L^{2′}, L^{3′}, L^{4′}, L⁵, L⁶Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹, R¹, R², m and m′ are each as defined in claim 1 comprising, reacting compounds with the following formula III 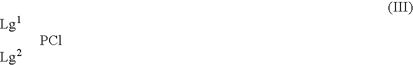
in which
Lg¹ and Lg² may be the same or different and are each a group selected from L¹-Y¹, L²-Y², L³-Y³, L⁴-Y⁴, L^{1′}-Y^{1′}, L^{2′}-Y^{2′}, L^{3′}-Y^{3′}, L^{4′}-Y^{4′}, L⁵-Y⁸ or L⁶-Y⁹,
in the presence of a base of a compound with the formula IV or V
H—Y⁵[R¹Y⁶]ₘ—H (IV)
H—Y^{5′}—[R²Y^{6′}]_{m′}—H (V)

7. A process for preparing compounds with the formula I or II 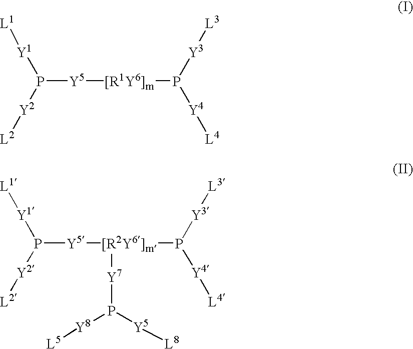
in which
L¹, L², L³, L⁴, L^{1′}, L^{2′}, L^{3′}, L^{4′}, L⁵, Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹, R¹, R², m and m′ are each as defined in claim 1, comprising reacting, compounds with the formula VI or VII
Cl₂P—Y⁵—[R¹Y⁶]ₘ—PCl₂ (VI) 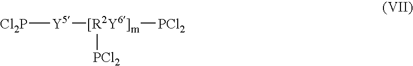
with ligands of the formula Lg¹ or Lg² to form compounds with the formulae I or II.

8. A catalyst comprising transition metal complexes of chiral compounds having the formula I and/or II 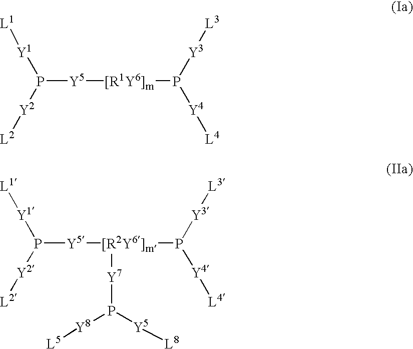
in which
L¹, L², L³, L⁴, L^{1′}, L^{2′}, L^{3′}, L^{4′}, L⁵ and L⁶ may each be the same or different and at least one of L¹, L², L³ and L⁴ in formula I or at least one of L^{1′}, L^{2′}, L^{3′}, L^{4′}, L⁵ and L⁶ in formula II is a chiral radical, where L¹ and L², L³ and L⁴, L^{1′} and L^{2′}, L^{3′} and L^{4′}, and L⁵ and L⁶ may be joined together,
Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹ may be the same or different and are each O, S or an NR′ group in which R′ is hydrogen or optionally substituted C₁-C₆-alkyl or optionally substituted aryl,
R¹ and R² are each optionally substituted C₂-C₂₂-alkylene, and
m and m′ are each between 1 and 1000.

9. A process for preparing transition metal catalysts comprising transition metal complexes of chiral compounds with the formula Ia and/or IIa comprising reacting transition metal salts with chiral compounds with the formulae I and/or II.

10. The process as claimed in claim 9, wherein the transition metal salts are selected from transition metals of groups VIII and Ib of the periodic table.

11. A process for asymmetric transition metal-catalyzed hydrogenation, hydroboration, hydrocyanation, 1,4 addition, hydroformylation, hydrosilylation, hydrovinylation and Heck reaction of prochiral olefins, ketones or ketimines, wherein the catalysts have chiral ligands with the following formulae I and/or II 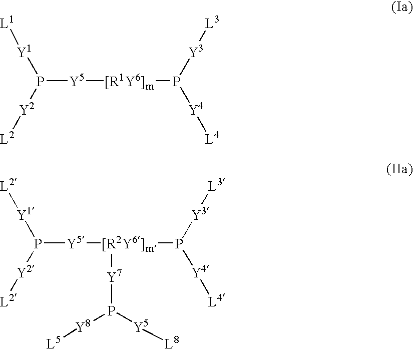
L¹, L², L³, L⁴, L^{1′}, L^{2′}, L^{3′}, L^{4′}, L⁵, Y¹, Y², Y³, Y⁴, Y⁵, Y⁶, Y^{1′}, Y^{2′}, Y^{3′}, Y^{4′}, Y^{5′}, Y^{6′}, Y⁷, Y⁸, Y⁹, R¹, R², m and m′ are each as defined in claim 9.

12. The process as claimed in claim 11, wherein the catalyst is selected from the following complexes in which Z is an anion from the group of BF₄⁻, BAr₄⁻, SbF₆⁻, and PF₆⁻, where Ar is phenyl, benzyl or 3,5-bistrifluoromethylphenyl.

13. A process for preparing chiral compounds in which the prochiral precursor selected from olefins, ketones or ketimines is subjected in the presence of a transition metal catalyst to hydrogenation, hydroboration or hydrocyanation, 1,4 addition, hydroformylation, hydrosilylation, hydrovinylation and Heck reactions, wherein the transition metal catalyst has ligands which are selected from compounds with the general formulae I and/or II.
